(19) United States
(12) Patent Application Publication
(10) Pub. No.: US 2004/0177039 A1
(43) Pub. Date: Sep. 9, 2004

(54) Systems and methods for maintaining and distributing a commerce catalogue

(76) Inventors: Simon Pincus, Markham (CA); Brett Watson-Luke, Indooroopilly (AU)

Correspondence Address: Schwegman, Lundberg, Woessner & Kluth, P.A., P.O. Box 2938, Minneapolis, MN, 55402, US

(21) Appl. No.: 10/683,171

(22) Filed: Oct. 10, 2003

Related U.S. Application Data
(60) Provisional application No. 60/417,972, filed on Oct. 10, 2002.

(51) Int. Cl. G06F 17/60

(52) U.S. Cl. 705/40

(57) ABSTRACT

A computerized system for maintaining a commerce catalogue includes a commerce manager operable to read an catalogue repository that includes XML schema data defining products and services. The commerce manager sends the XML schema data to a publisher operable to forward the data to a particular viewing agent. In addition, the commerce manager communicates with a listener to receive XML schema data defining products and services.

### RELATED FILES

This application claims the benefit of U.S. Provisional Application No. 60/417,972, filed Oct. 10, 2002, which is hereby incorporated herein by reference for all purposes.

### FIELD

The present invention relates generally to computerized systems for maintaining a catalogue of data, and more particularly to systems for maintaining and distributing a commerce catalogue of products and services.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2002, ADC Telecommunications, All Rights Reserved.

### BACKGROUND

Until now Communication Service Providers operated a closed service model providing customers with access to voice based services supplemented by a number of different network applications that were only supported within the confines of the service provides chosen switching platforms. Customers could only get these network applications from the same service provider that gave them access to the primary network for voice or cable TV based services.

There has been a migration of voice based networks to provide access to the Internet via a simple dial-up access through to more advanced broadband technologies, such as wireline DSL, T1/E1 digital bearers, leased data networks, wireless 2.5G/3G mobile networks to the cable TV industries Digital Web TV and cable modems. The convergence of these three primary network and service domains with the Internet will introduce a new dimension to value added services that includes content, information and access to Internet based commerce. Each new service dimension introduces a new business process paradigm that will involve third parties to supply content and to fulfill the delivery of content and Internet commerce based services, all of whom will want to be compensated for the supply of this content, information or commerce based transactions.

Today's telecommunication solutions typically include functionality to create and maintain product and service information. However this functionality is specific to the COTS (Customer Off the Shelf) solution and will often require adaptation to fit into an active service providers OSS (Operational Support System) architecture. This often results in a subset of duplicate product data residing across multiple OSS platforms. For an implementation perspective this typically requires lengthy analysis to determine which system should be the master. In many cases the billing system is usually the primary source and all other systems are slaves to the billing system's product and pricing definition.

Once this is agreed the communication providers then find themselves in the dilemma of how to maintain the product data integrity across their partial integrated or disparate OSS platforms due to a lack of suitable tools to support the updating of product information. More often than not this results in a mammoth task of duplicate data entry to update all the product repositories on each of the individual OSS platforms. This is further compounded where changes affect pricing and provisioning eligibility rules can create a waterfall affect of where the updates need to be applied in a specific order not only across the base product definition, but potential active customer records and service orders in the system. The final stage may then include another mammoth task of reconciling product information across these disparate systems to give the service provider some confidence towards revenue assurance.

For example, many of the components of a traditional OSS infrastructure rely on internal product and service lists. Each component typically records attributes relevant to their specific domain in a proprietary format and repository. For 3G providers, the service portal and mCommerce (mobile commerce) platforms are additional domains that maintain independent product information. For many providers, creating or maintaining products is an expensive, time consuming and manual administrative task. There have been two ‘generations’ of attempts to resolve this problem.

The first generation involved selecting a system as the ‘master’ and developing scripts to automate the process of synchronizing a subset of common product attributes (e.g., name, description, identifier, active date range, pricing). This approach can be partially successful. It relies heavily, however, on a specific proprietary format. It is expensive to maintain and difficult to extend.

The second generation involved purchasing a separate system that focused on product creation and maintenance. These systems were typically sales focused, with little or no emphasis on other OSS domains. In general, the new systems made the problem worse.

In view of the above, there is a need in the art for the present invention.

### SUMMARY

The above-mentioned shortcomings, disadvantages and problems are addressed by the present invention, which will be understood by reading and studying the following specification.

On aspect of the present invention is a computerized system for maintaining a commerce catalogue that includes a commerce manager operable to read a catalogue repository that includes catalogue schema and sub-schema data defining products and services. The commerce manager sends the catalogue schema data to a publisher operable to forward the data to a particular viewing agent. In addition, the commerce manager communicates with a listener to receive catalogue schema data defining products and services.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of a hardware and operating environment in which different embodiments of the invention can be practiced;

FIG. 2 is a diagram illustrating a structure of an XML schema and sub-schema according to an embodiment of the invention; and

FIG. 3 is a flowchart illustrating a method for maintaining a commerce catalogue according to an embodiment of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions that follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

Some embodiment of the invention may be implemented using Java based system such as J2EE and JSEE. The detailed description below uses terminology, components, and functions common to Java based systems. However, the invention is not limited to such systems, and equivalents to such systems may be utilized in various embodiments. Such alternative implementation systems are included within the scope of the invention.

The following table presents definitions of terms and acronyms used in the detailed description and appendices that follow. Some of the terms are in common usage in the art, while others are specific to the present invention.

| Acronym | Name | Definition |
|---|---|---|
| API | Application | A set of routines, protocols, and tools for building |
| | Programming Interface | software applications |
| ARPU | Average Revenue Per | The term used by the Telecommunication |
| | User | Industry to describe the Average Revenue Per User |
| | | spent on associated products and services |
| B2B | Business To Business | A term used to describe the a process of |
| | | interaction between two business |
| B2C | Business to Consumer | A term used to describe the a process of |
| | or Customer | interaction between a business and a customer |
| C2B | Consumer 2 Business | Where consumers make contact with business |
| | | for the purposes of conducting business that |
| | | results in a transaction with or without |
| | | payment for products or services supplied |
| CB | Convergent billing | |
| CIP | Content Information | An organization that provides a service of |
| | Provider | supplying content and information based |
| | | services to businesses and consumers. |
| COTS | Customer Off The | An acronym used in the industry to describe |
| | Shelf Software | commercial available software also referred to |
| | | as ‘Shrink Wrapped’. |
| DBMS | Database management | |
| | system | |
| DOM | Document object | |
| | model. | |
| DTD | Document Type | A DTD is a Document Type Definition. A |
| | Definition | DTD is not required by XML documents, but |
| | | may be used. |
| EAI | Enterprise application | |
| | integration. | |
| EDGE | Enhanced Data GSM | A faster version of GSM wireless service |
| | Environment | |
| EJB | Enterprise Java bean. | |
| GPRS | General Packet Radio | |
| | System | |
| HTML | Hypertext markup | |
| | language. | |
| ICM | Integrated customer | |
| | management. | |
| J2EE | Java 2 enterprise | A packaging of the Java enterprise APIs, |
| | edition: | including EJB, JMS, JAXP, ... |
| J2SE | Java 2 standard edition: | The base Java APIs. |
| JAAS | Java authentication and | |
| | authorization service. | |
| JAXB | Java architecture for | |
| | XML binding. | |
| JAXM | Java API for XML | |
| | messaging. | |
| JAXP | Java API for XML | |
| | parsing. | |
| JAXR | Java API for XML | |
| | registries. | |
| JDBC | Java database | |
| | connectivity | |
| JMS | Java messaging service. | |
| JMX | Java management | |
| | extensions. | |
| JNDI | Java naming and | API for accessing naming and directory |
| | directory interface. | services such as LDAP, CORBA naming |
| | | service, Java RMI registry, etc. |
| LDAP | Lightweight directory | |
| | access protocol. | |
| MDB | Message driven bean. | |
| MOM | Message oriented | |
| | middleware. | |
| OSS | Operational support | |
| | system. | |
| RMI | Remote method | Java mechanism for remote procedure call. |
| | invocation. | |
| SAX | Simple API for XML | |
| Servlet | Java class that can | These run in a J2EE servlet container and |
| | process web requests. | conform to a standard interface |
| SOAP | Simple object access | |
| | protocol. | |
| SSL | Secure sockets layer. | |
| UMTS | Universal Mobile | |
| | Telephone Service | |
| W3C | World wide web | |
| | consortium | |
| WAP | Wireless Application | An open, global specification that empowers |
| WML | Protocol/Wireless | mobile users with wireless devices to easily |
| | Markup Language | access and interact with information and |
| | | services instantly. |
| XML | Extensible Markup | The universal format for structured documents |
| | Language | and data on the Web |
| XML | | Provides a means for defining the structure, |
| Schema | | content and semantics of XML documents. |
| XSL | Extensible stylesheet | |
| | language | |
| XSLT | XSL transformations | |

The following detailed description is, therefore, not to be taken in a limiting sense, and the scope of the present invention is defined only by the appended claims.

### Operating Environment

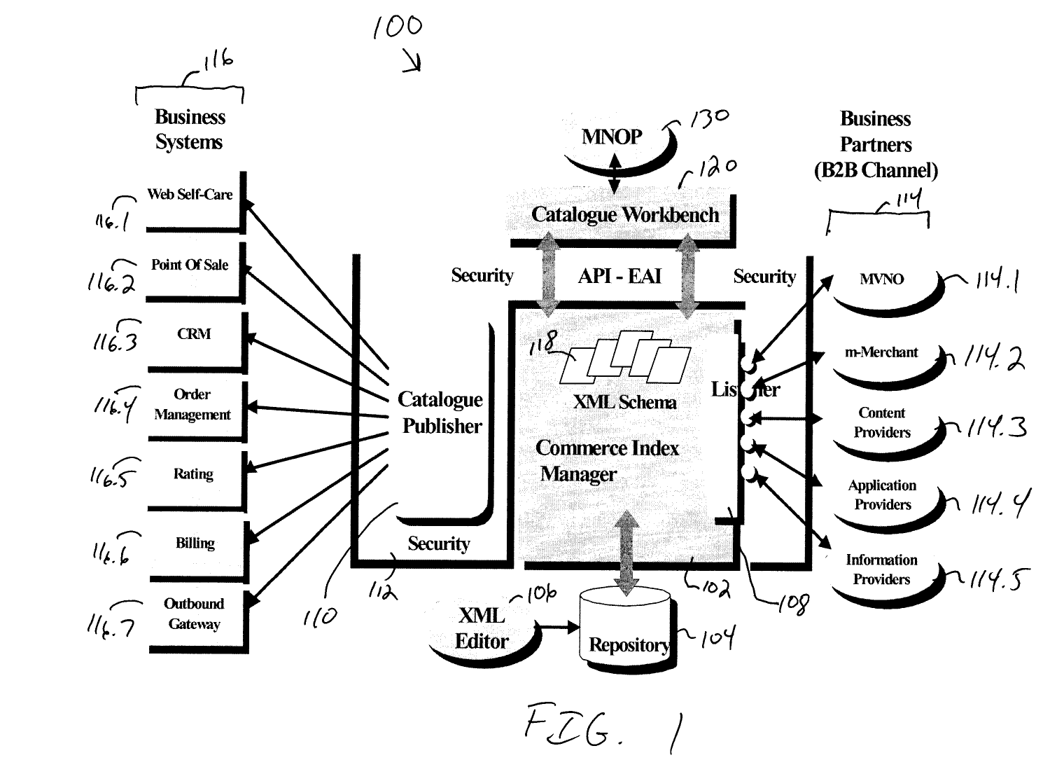

FIG. 1 is a block diagram of a hardware and software environment 100 incorporating various embodiments of the invention. The systems and methods of the present invention may be provided on a variety of hardware and software systems, including personal computers, server computers and mainframe computers and may be stored on and executed from various computer-readable media such as RAM, ROM, CD-ROM, DVD-ROM, hard disks, floppy disks, Flash Memory, Compact Flash etc. In one embodiment of the invention, environment 100 includes commerce index manager 102 (also referred to as a catalogue manager), catalogue repository 104, XML editor 106, catalogue publisher 110, listener 108, and security component 112.

Commerce index manager 102 manages interactions with the catalogue repository 104 enforcing security (through security component 112) on updates to the catalogue, maintaining catalogue integrity, and ensuring that systems are notified of updates to the catalogue. In general commerce index manager 102 provides one or more of the following functions:

Providing transactional updates to the catalogue.

Managing the persistence of the catalogue.

Validation updates to the catalogue.

Enforcing security on catalogue updates and reads.

Auditing catalogue changes.

Providing mechanisms for publishing the catalogue into OSS systems.

Notifying clients when the catalogue changes so they can reflect these changes.

Providing facilities for clients to search the catalogue.

In some embodiments, commerce index manager 102 may be implemented using various Java based tools. In such embodiments, enterprise Java beans (EJBs) may be used to represent catalogue entities and entities that provide business interfaces to these entities. Additionally, the system may include servlets that accept SOAP requests from B2B partners, and invoke the core EJBs to perform the requests.

Catalogue repository 104 may be used to store product and service information that comprises a commerce catalogue. It provides persistence and reliable storage for schemas such as XML schema 118. In some embodiments, catalogue repository 104 may be a relational database, such as the Oracle Relational Database management system. In some embodiments, catalogue data may be stored in a number of relational tables, with XMLType used for catalogue extensions. In alternative embodiments, XML data may be mapped to relational tables or stored as blob data.

In some embodiments, catalogue repository 104 may be an XML repository comprising an XML database. Such databases include the GoXML, XML Canon, Tamino, X-Hive/DB and Documentum XML databases

In some embodiments, Data access objects (DAO) may be used to actually read and write catalogue information to persistent storage such as catalogue repository 104. Utilizing a DAO interface is desirable because it allows for storage of entity beans to be independent of the storage mechanism (e.g. relational DB or XML DB).

Data in catalogue repository 104 may comprise data describing aspects of online commerce, including physical communication equipment (e.g. handsets, equipment accessories), services of a logical nature (e.g. network applications, connection type, maintenance contracts), content and information such as games, movies, location based Services, and physical goods and services under a commerce domain.

XML editor 106 comprises an XML editing tool used to define and maintain XML schema data such as schema 118 in repository 104. Such XML editors are known in the art, and the invention is not limited to any particular type or brand of XML editor.

Channels 114 provides access to the commerce index manager 102, and in some embodiments may be used to provide approved third party suppliers, resellers and retailers to a mechanism to publish their product information in a standard XML format and to be notified of changes to the catalogue. The service provider along with the approved agents and resellers, may be given buying and selling privileges within the confines of the commerce catalogue, to select and repackage existing listed products and service into unique and in-vogue combinations to entice customer interest.

In some embodiments of the invention, environment 100 includes catalogue workbench 120 (also referred to as a product workbench). Workbench 120 comprises a software configuration component that may be used to facilitate the creation and maintenance of product information by a catalogue owner such as Mobile Network Operator 130. The workbench 120 typically supports administration type tools to support with the maintenance of the commerce catalogue and base XML schemas. As well as making changes to the catalogue and schema, the catalogue workbench 120 is used to maintain user access and security, add or maintain the publisher and listener agents, and connect to the underlying OSS platform 116 or B2B Channels 114.

XML schema 118 comprises an open specification for the information that can be stored about products and services. The schema provides an open standard format that may be made available to other OSS components to source or update product information. In some embodiments, the schema includes support for domain specific extensions.

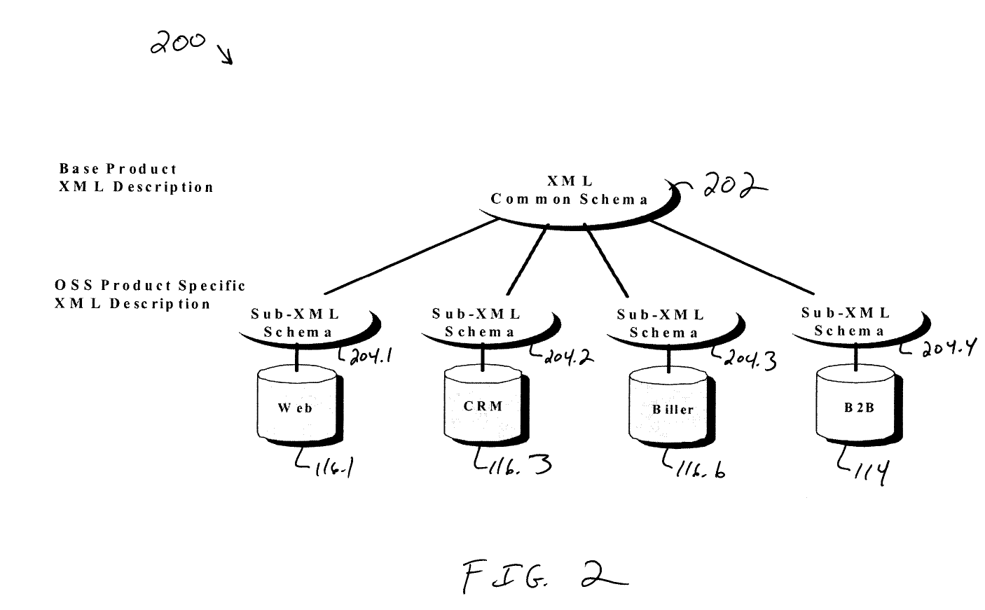

FIG. 2 provides a graphical illustration of a structure 200 of a schema according to some embodiments of the invention. In some embodiments, the commerce index schema 118 is defined using the XML Schema language, as specified by the World Wide Web consortium. In some embodiments, in order to implement a domain specific extension facility, schema 118 includes some or all of the following functionality:

It utilizes the XML Schema type extension facility.

Complex types may be defined for elements at each of the schema extension points.

These complex types may be abstract.

The domain specific extensions 204 to the commerce index may be implemented as XML Schema extensions of the complex types.

For example, in some embodiments of the invention, there is a ComponentExtensionType which is a complex type, defined in the common schema 202. The component element of the catalogue schema allows any number of occurrences of elements of this type within its body. (component elements are used to represent catalogue items). For example, in some embodiments, a CB_Component may be declared in a sub-XML biller schema 204.3. It may be declared to be an extension of the ComponentExtensionType.

In some embodiments, schema 118 is structured so that common schema 202 includes the following:

It defines information that is generally of interest to many or all OSS components. This is known as the common information. This includes information such as:

Overall catalogue information, such as:

Catalogue owner

Last update

Categories of items in the catalogue, for which information such as the following is stored:

Name

Description

Relationship to other categories (to for hierarchies of categories).

Catalogue item (e.g. product or service) information. These are known as catalogue components. Information like the following is stored for each component:

Name

Description

Categories that this component belongs to.

The type of the component (for example, base product, service, equipment, contract).

Compatibility rules: what catalogue items this product is or isn' t compatible with.

Composition rules: what catalogue items this product is composed of. This can be used to model product bundles.

It defines extension points that can be used to extend the schema to provide additional product information that is of use only to particular OSS components. These are known as domain extensions, also referred to as Sub-XML schema 204. In this context domains may be:

Particular OSS components (e.g. the biller 216.6)

Logical groupings of information (e.g. cross selling information) Extensions may be to:

The information for particular products/services (catalogue items).

The information for particular categories of catalogue items.

The catalogue as a whole.

In view of the design of the schema, new domain specific extensions 204 may be added to the catalogue schema without any impact on tools (for example publishers) that are aware of and process the existing schema and extensions that are of interest to them.

Returning to FIG. 1, in operation, commerce index manager 102 ensures that OSS components (e.g. viewing agents 116) and other interested parties (third parties via the B2B channel 114, or workbench 120 or other tools that are used to examine and manipulate the catalogue) are notified of changes. This may be done via the publishers 110 and listeners 108. Publishers may exist for each of the OSS components that the commerce index manager 102 is to inform of updates.

Catalogue publisher 110 may be used to maintain the integrity of product information across OSS platforms that need access product and service information in the catalogue. In some embodiments, the publishing mechanism may be automated and distribute data across a distributed OSS platform to and from business systems 116 such as Web, Customer Care, Order Entry, Provisioning, Rating, and Billing systems 116 also referred to as viewing agents 116). Catalogue Publisher 110 may also be used to publish to an Outbound Gateway (e.g. Unified Messaging) as a sales promotional tool to alert customers to new products and campaigns.

In some embodiments, publishers 110 may use a reliable delivery mechanism to insure delivery of messages by using persistent publishing and by using durable subscriptions. For example, in some embodiments, a reliable delivery message of JMS may be utilized,.

In some embodiments, each publisher is an MDB that knows how to process notifications and update the business system for which it is designed. A publisher may only be interested in certain types of notification (e.g. only product changes, and not category changes). The delivery of notifications to the MDB may be controlled by specifying message filters in the deployment descriptor for the MDB. That is, this task may be handled by the application server.

Listener 108 describes clients, systems or modules that are interested in changes to the catalogue, but that do not require absolute reliable delivery of these notifications. Typically tools for editing the catalogue may benefit from knowledge of changes to the catalogue content, but need not necessarily be guaranteed that they receive all updates. These are also not normally durable subscriptions-because the notifications are only required for the period when the catalogue is actually being accessed.

Third parties such as business partners 114 may want to be notified about catalogue changes. In some embodiments, this may be done by registering to receive notifications. Notifications may then be sent to the listener. In some embodiments, the messages may be sent as SOAP messages, delivered either by HTTP or via SMTP. Because acknowledgement of these notifications is not necessarily required, these need not be guaranteed reliable notifications In some embodiments, listeners 108 may also supported using MDBs. For example, there may be an MDB that sends notifications to clients that have registered for notification, and another MDB that sends notifications to B2B partners. The notifications that this MDB provides may be controlled by rules. Unlike the publishers, listeners typically do not need to support guaranteed delivery of notifications, so they need not be transactional, nor do the listeners need to have durable subscriptions to the notifications.

The commerce index manager 102 also provides a mechanism that systems or clients can use to register for notification of updates. In some embodiments, unlike the publishers 110, these listeners 108 are not guaranteed to receive the notifications. In both cases the notifications may be performed asynchronously so as to not create performance bottlenecks in updating the catalogue, and the notifications are independent of the catalogue updates (so updates can proceed even if parts of an OSS are unavailable).

In some embodiments, the notification mechanism makes use of reliable message-oriented middleware. Specifically, the catalogue manager writes change notifications to a reliable and persistent message delivery mechanism (For example, a Java messaging service topic). The publishers process the notifications. In some embodiments, the publishers 110:

Implement durable subscriptions to the topic, so that if they are unavailable, they do not miss notifications.

May be implemented as message driven beans. This allows third parties to easily create new publishers, as they follow a standard model.

May be transactional so that notifications are not removed until they have been successfully processed, in order to ensure reliable update to the OSS.

Publishers may receive only a subset of notifications, by utilizing the EJB 2.0 facilities for specifying filters that apply to message driven beans.

Publishers 100 may be free to implement any range of mechanisms for updating their respective OSS components. This allows the implementation to be tailored to suit the APIs or interfaces that are available for particular OSS components.

Because publishers 110 may handle specific OSS components, they are typically interested in the common catalogue information 202, plus domain extensions 204 that apply to the OSS component 116. The design of the catalogue schema allows publishers to ignore domain extensions that do not apply to them, and to process the information in the domain extensions that do apply to them.

In some embodiments, the messages and transaction between publishers, listeners, business systems and channels may be operated on by security component 112. In some embodiments, security component 112 may provide one or more of the following functions:

Authentication of users that are reading or modifying the catalogue.

Authorization of reads and updates to the catalogue.

Auditing changes to the catalogue so that an administrator can determine who made a particular change and when it was done.

Privacy protection: ensuring only end users can see the information being sent between them and the catalogue manager.

Integrity: ensuring the information sent has not been altered.

In some embodiments, the first three functions above may be provided using facilities such as a Java Authentication and Authorization service (JAAS). Other mechanisms that may be used in various embodiments include:

JNDI: Can obtain login username/password from a directory service available via JNDI (e.g. LDAP).

Kerberos

NT login

Unix login

Using a keystore.

The last two functions are typically an issue for third party interactions with the catalogue over a network such as the internet. In some embodiments, these functions may be met by utilizing technologies such as secure sockets layer (SSL) provided by the hosting web/application server for the B2B interface.

In some embodiments, an auditing function may be implemented by recording all changes to the catalogue in an audit table in the database. The table may contain:

The type of the entity updated (category, component, extension, catalogue summary).

The id of the entity updated.

The type of operation (create, update or delete).

The date/time at which the change was made.

The XML representation of the item before (and potentially after) the update.

In some embodiments, a Java session bean may be provided to read and write audit events to the audit table.

In some embodiments, and in particular in some Java based embodiments, the components described above may be run in two different types of application servers: an EJB container and a servlet container. In some embodiments, the core catalogue manager runs in an EJB container and provides:

A standardized application environment, with proven portability.

Transaction support, including two phase commit (if required).

Choice in application servers (There are a multitude of vendors with tested J2EE conformance.).

Security (container managed authorization).

Distributed application server support, failover, etc for high performance and availability, for customers that require it.

Easy integration of EAI tools (via Java APIs, JMS, etc) and OSS components (via Java APIs, or the Java connector architecture).

Further, in some embodiments, the B2B channel components 114 run in a servlet container (inside a web server). A servlet container may also be a J2EE container. In some embodiments, the B2B channel servlet provides:

Connectivity to clients via HTTP.

SSL for security.

SOAP support via JAXM.

Performs some processing of client requests.

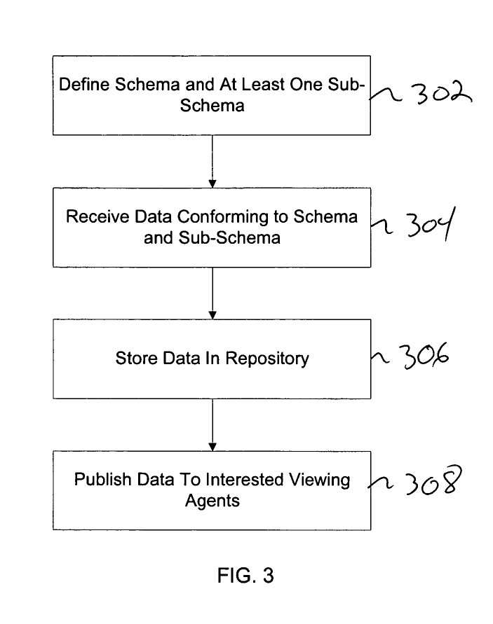

FIG. 3 is a flowchart illustrating methods for maintaining and distributing a commerce catalogue according to embodiments of the invention. The method to be performed by the operating environment constitute computer programs made up of computer-executable instructions. Describing the methods by reference to a flowchart enables one skilled in the art to develop such programs including such instructions to carry out the methods on suitable computers (the processor or processors of the computer executing the instructions from computer-readable media). The methods illustrated in FIG. 3 are inclusive of acts that may be taken by an operating environment executing an exemplary embodiment of the invention.

The method begins by defining a schema and at least one sub-schema for a catalogue database (block 302). In some embodiments, the schema and sub-schema may be defined in the XML language. Typically more than one sub-schema may be defined, with each sub-schema containing data definitions, formats, and rules relevant for a particular domain such as business system 116 or channel 114.

Next, a system executing the method receives catalogue data conforming to the schema and the at least one sub-schema (block 304). In some embodiments, the catalogue data may be received from a third party via a channel 114 such as a B2B channel. The catalogue data may define a product or service offering such as an application that may be run on a mobile device, information that may be presented to a mobile device user or other content that may be presented to a mobile device user. Additionally, the catalogue data received may result in the creation, reading updating or deleting of catalogue data.

In some embodiments, the system stores the catalogue data in a catalogue repository (block 306). As noted above, the catalogue repository may be an XML repository. In some embodiments, the system validates the data prior to storing the catalogue data. The validation rules may be provided by the schema or sub-schema.

Next, the system publishes the catalogue data to one or more viewing agents (block 308). The catalogue data may be filtered according to a sub-schema of interest to the viewing agent. For example, the catalogue data may contain a common schema defining a product or service and also contain various sub-schemas specific to particular systems. For example, one sub-schema may define a part number and description for a product to be used by an order management system 116. while another sub-schema may define billing data for the product or service. In some embodiments, a billing system 116.6 will receive the common schema and sub-schema data relevant for billing, while the order management system receives the sub-schema for the part number and description. The schema or sub-schema may define translation rules for the destination system so that in some embodiments, the data is published in a format acceptable to the destination business system 116. In alternative embodiments, the data may be translated by the business system itself.

It should be noted that publishing the catalogue data may comprise sending a notification to the interested systems (e.g. systems that have subscribed to the data) that new data is available. The systems may then pull the new data from the commerce catalogue.

In some embodiments, the communications such as receiving catalogue data and publishing catalogue data may be performed using messages. Utilizing messaging in this way creates a looser coupling between the catalogue manager and the other OSS components. Using JMS is also desirable for communicating with the OSS. JMS has been widely adopted by both newcomers to the MOM arena and established players. With wrappers around some of the major MOM systems (such as MQSeries) and adapters available from vendors to allow communication to other MOM systems (such as TIBCO Rendezvous), allowing for integration with other system. For example, the messaging interface may be used for integration with workflow systems.

### Conclusion

Systems and methods for maintaining and distributing commerce catalogue data are disclosed. The systems and methods described provide advantages over previous systems.

The system and methods of the embodiments of the invention provide innovative novel approach to the creation and management of the provider' s product and service catalogue. For example, the catalogue becomes an open, accessible, front-office tool. Through the use of a commerce catalogue, the embodiments of the invention may support:

A rich, extensible, product model

Commerce, content and value-added services

Automatic synchronization of multiple OSS components

Catalogue personalized to a specific segment or individual customer

Business-to-business updates from a third party content or services supplier

By providing an open and accessible format for product definitions, the provider and their suppliers can offer the products that their customers want, when they want them.

The embodiments of the invention provide an extensible product model. The attributes modeled in the catalogue are applicable across multiple domains, including sales information, target segmentation, pricing, component hierarchies, eligibility criteria and ordering rules.

Thus the embodiments of the invention provide a means for automating the processes of pulling product and service content from multiple channels, normalizing the data into a common representation, and delivering it to targeted disparate but integrated solutions and outbound gateways in a consistent manner and format

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

1. A computerized system for maintaining a commerce catalogue, the system comprising:
an catalogue repository including catalogue schema data;
a commerce index manager operable to read and write catalogue schema data to the catalogue repository;
a publisher operable to send the catalogue schema data to a viewing agent; and
a listener operable to receive catalogue schema data from a product or service supplier;
wherein the catalogue schema data comprises a common schema and a sub-schema.

2. The system of claim 1, wherein the catalogue repository comprises a relational database.

3. The system of claim 1, wherein the catalogue repository comprises an XML database.

4. The system of claim 1, wherein the common schema and the sub-schema are defined using XML.

5. The system of claim 1 further comprising a security component operable to authorize and authenticate transactions for the catalogue repository.

6. The system of claim 1, wherein the viewing agent comprises an OSS component.

7. The system of claim 6, wherein the OSS component is a billing component.

8. The system of claim 6, wherein the OSS component comprises a web self-care component.

9. The system of claim 6, wherein the OSS component comprises an order management component.

10. The system of claim 6, wherein the OSS component comprises a rating component.

11. The system of claim 6, wherein the OSS component comprises a customer relationship management component.

12. The system of claim 1, wherein the product or service supplier comprises a content provider.

13. The system of claim 1, wherein the product or service supplier comprises an application provider.

14. The system of claim 1, wherein the product or service supplier comprises an information provider.

15. A method for maintaining a commerce catalogue, the method comprising:
defining a schema and at least one sub-schema for a catalogue database;
receiving catalogue data conforming to the schema and the at least one sub-schema;
storing the catalogue data in a catalogue repository; and
publishing the catalogue data to a viewing agent, wherein the catalogue data is filtered according to a sub-schema of interest to a viewing agent.

16. The method of claim 15, wherein the catalogue data is filtered by the viewing agent.

17. The method of claim 15, wherein the catalogue data is filtered prior to publishing to the viewing agent.

18. The method of claim 15, wherein receiving the catalogue data comprises receiving the catalogue data from a content provider.

19. The method of claim 15, wherein receiving the catalogue data comprises receiving the catalogue data from an application provider.

20. The method of claim 15, wherein publishing the catalogue data includes translating the catalogue data into a format used within the viewing agent.

21. The method of claim 15, wherein the viewing agent comprises a billing system.

22. The method of claim 15, wherein the viewing agent comprises a rating system.

23. A computer-readable medium having computer executable instructions for performing a method for maintaining a commerce catalogue, the method comprising:
defining a schema and at least one sub-schema for a catalogue database;
receiving catalogue data conforming to the schema and the at least one sub-schema;
storing the catalogue data in a catalogue repository; and
publishing the catalogue data to a viewing agent, wherein the catalogue data is filtered according to a sub-schema of interest to a viewing agent.

24. The computer-readable medium of claim 23, wherein the catalogue data is filtered by the viewing agent.

25. The computer-readable medium of claim 23, wherein the catalogue data is filtered prior to publishing to the viewing agent.

26. The computer-readable medium of claim 23, wherein receiving the catalogue data comprises receiving the catalogue data from a content provider.

27. The computer-readable medium of claim 23, wherein receiving the catalogue data comprises receiving the catalogue data from an application provider.

28. The computer-readable medium of claim 23, wherein publishing the catalogue data includes translating the catalogue data into a format used within the viewing agent.

29. The computer-readable medium of claim 23, wherein the viewing agent comprises a billing system.

30. The computer-readable medium of claim 23, wherein the viewing agent comprises a rating system.
